(19) United States
(12) Patent Application Publication
(10) Pub. No.: US 2004/0044604 A1
(43) Pub. Date: Mar. 4, 2004

(54) Method to improved debt collection practices

(76) Inventor: Patrick G. O'Neil, Wilmette, IL (US)

Correspondence Address: VEDDER PRICE/ACCENTURE, 222 NORTH LASALLE STREET, CHICAGO, IL, 60601, US

(21) Appl. No.: 10/229,803

(22) Filed: Aug. 28, 2002

(51) Int. Cl. G06F 17/60

(52) U.S. Cl. 705/35

(57) ABSTRACT

Debt collection strategies that have been used successfully on certain types of debtors are more likely to yield results than unproven strategies. Non-financial, non-historical behavioral Characteristics of debtors who responded to collection strategies are used to identify future debtors against whom previously-successful strategies should be repeated to provide a rate of payment higher based on historical behavioral/financial attributes.

### FIELD OF THE INVENTION

This invention relates to the business of debt collection. In particular, this invention relates to a method for improving debt collection.

### BACKGROUND OF THE INVENTION

The extension of unsecured credit by banks, credit card issuers and merchants has created an explosion of unsecured consumer debt. Many consumers are indebted well-beyond their ability to pay unsecured debts and, as a result, account balances and even the so-called minimum payments due on their credit accounts become overdue or “delinquent.”

Creditors attempt to collect overdue balances and overdue payments using a variety of techniques, also referred to herein as debt collection “strategies.” Written correspondence, such as a letter, is typically used first. Letters are often followed by telephone calls. Telephone calls may be scheduled for a certain time of day. Whether a communication with a debtor is written or oral, it will comprise a message, which may be threatening or conciliatory. The communication with the debtor is such that payment options may (or may not) be offered, providing varying degrees of flexibility to the debtor to provide payment on the past due account. The contact with the debtor may be handled by collections personnel who are highly trained, experienced employees with excellent negotiating skills, or by relatively inexperienced collectors, with less developed skills. The combination of these and other elements of customer interaction comprise a treatment strategy, and each treatment strategy is intended to yield a result.

The process of debt collection has become sophisticated. Whether a debtor is threatened or consoled, debt collection processes frequently use historical payment and credit data as predictors of future payment likelihood, and as a basis for determining treatment strategies. However, historical payment data has not heretofore been used in conjunction with debtor socio-psycho-demographic attributes to improve debt collection by identifying clusters of debtors of the same risk/delinquency categorization that are more likely to respond to one treatment strategy as opposed to another treatment strategy.

FIG. 1 depicts a simplified representation of a prior art debt collection process 100. Extrinsic or external payment data 102, which is typically collected by and available from third party debt collection data services such as Equifax, Inc., Experian Inc. and others, includes debtor data such as income, debt-to-income ratio, other creditors and a “credit score” which is usually a dimensionless index calculated by the third party credit reporting agency using a proprietary formula to attempt to rate or grade the credit worthiness of the debtor.

In addition to external data 102, prior art debt collection processes used by many creditors also use internal data 104, which is data on a particular debtor that is collected by a creditor. Internal data 104 typically includes the creditor's payment history, his purchase history and contact history. The payment history 106 typically includes the historical timeliness of required loan or installment payments by a creditor. Payment history data 106 can be valuable in collecting debt if the payment history data 106 shows that a particular debtor is either habitually late or delinquent in making payments, or consistently makes payments on time. Payment history data 106 can be a good indicator of future payment likelihood.

Purchase-history data 108 typically includes data of the business relationship with the debtor over time. A long-time customer evidenced by purchase-history data 108 might be treated differently than a new customer. Accordingly, purchase-history data 108 is frequently considered during a debt collection effort.

A contact history or record 110 is typically a record of the substance of communications to and from a debtor. Contact history data 110 wherein previous conversations with or correspondence from a debtor contain debtor represent that payments will be forthcoming but which subsequently prove to be false, can be helpful in determining how to collect an existing debt.

A raw credit score 112 is typically a dimensionless index that is calculated using a creditor-proprietary formula or methodology, the resultant numerical value of which provides some sort of measure of the debtor's credit worthiness. A credit score is based upon historical data and relies upon historical data as a predictor of future payment likelihood.

Contact information 114 typically includes phone numbers, addresses and other information useful in identifying and contacting or locating a debtor.

In prior art debt collection processes, external data 102 and internal data 104 are analyzed alone or in combination, in step 120 in order to determine a risk profile 122 as well as a model of the debtor's behavior 124. The task of collecting all or part of debt is assigned to a debt collector in step 130 based upon the risk profile 122 and behavior model 124 of the debtor.

A problem with prior art debt collection techniques is that they rely upon historical financial and payment data in determining whether or not to pursue debt collection as well as the techniques of how to pursue debt collection. These historical facts are not always accurate predictors of a debtor's future behavior nor do financial and payment facts suggest the collection techniques that a debtor will more likely respond to.

Almost all creditors have many more delinquent debtors than they do collection agents to pursue debt collection. A method by which a creditor can ascertain the treatment that is most likely to persuade a debtor to make a payment on outstanding debt, thereby reducing the number of required contacts and the amount of debt charged off, would provide a significant improvement over the prior art.

### SUMMARY OF THE INVENTION

A method of optimizing debt collection identifies delinquent debtors (also known as delinquent credit accounts) from which debt collection has been attempted. Of the delinquent accounts from which collection was attempted, the particular collection attempts that were successful are identified. A debt collection attempt is considered “successful” if some repayment was realized, a re-payment promise or commitment was made, or some security interest for the debt was provided.

Of the successful collection attempts, the collection strategies that were used in each successful attempt are identified and catalogued so as to yield one or more collection strategies that were at least partially successful. For each successful collection strategy, nonfinancial, non-payment characteristics of the debtor (or of the account) are catalogued from which collection was obtained, e.g. socio-psycho-demographic data. Of the debtors (or accounts) from which a particular strategy was effective, debtor (or account) socio-psycho-demographic characteristics that are in common, if any, are identified. The characteristics common to debtors from which a repayment was realized in response to a particular collection strategy are used to identify other delinquent debtors having the same or similar characteristics. The collection strategy previously used successfully against delinquent debtors is re-used against other delinquent debtors having the same, or similar characteristics.

The socio-psycho-demographic categorization of the accounts can be used in conjunction with prior art techniques, or independent of prior art techniques to provide a more effective collections process.

### BRIEF DESCRIPTION OF THE DRAWINGS

FIG. 1 depicts a prior art method of collecting debt.

FIGS. 2-1; 2-2 and 2-3 depict steps of a preferred embodiment of the present invention.

### DETAILED DESCRIPTION OF A PREFERRED EMBODIMENT

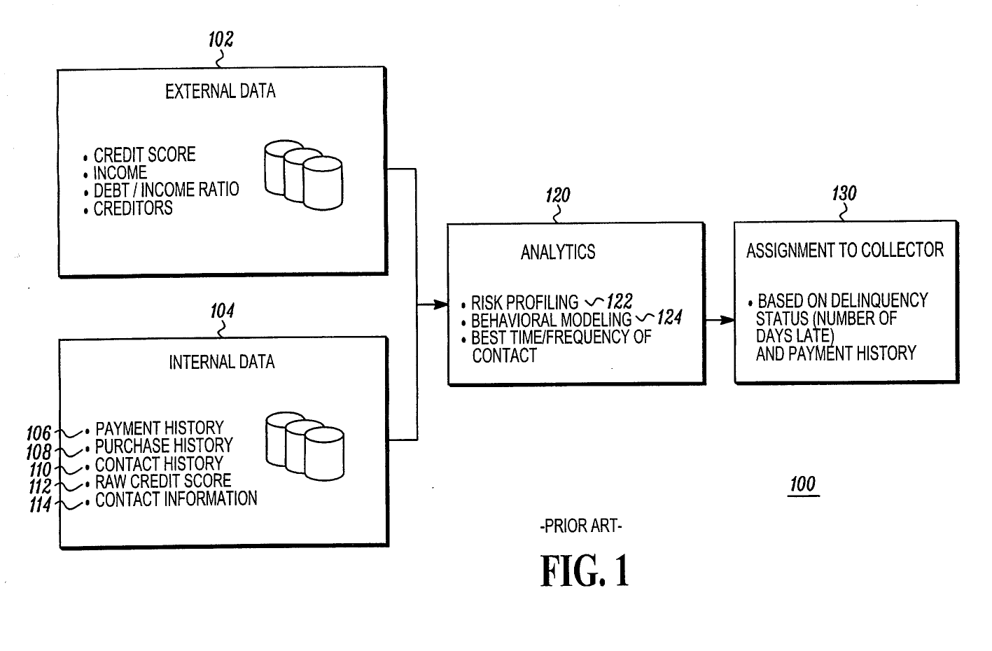

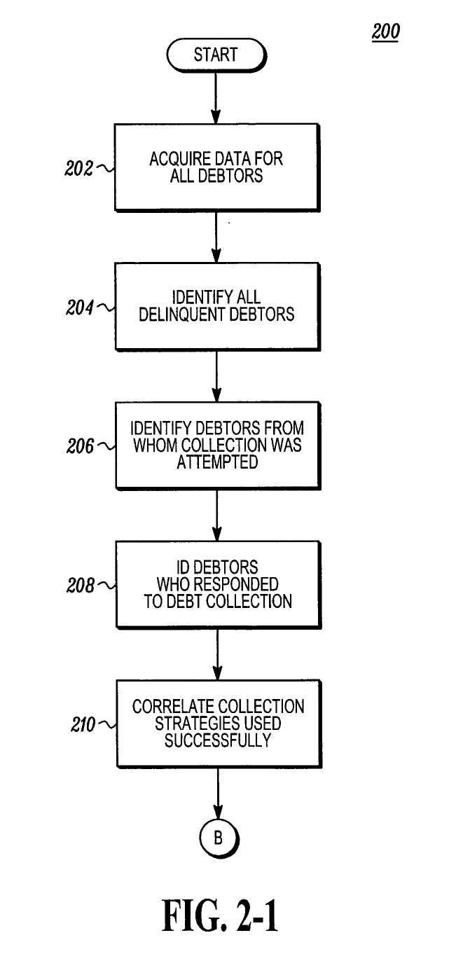

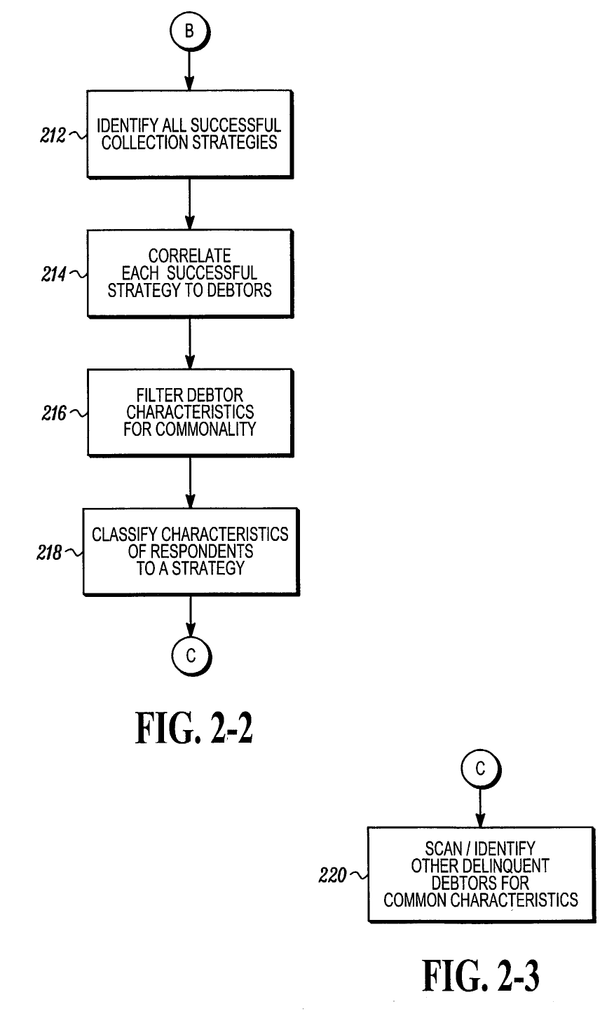

FIGS. 2-1, 2-2 and 2-3 depict steps of a debt collection method 200. In the preferred embodiment, the steps of the method depicted in the flow chart of FIG. 2-1, 2-2 and 2-3 are capable of being performed by one or more individuals, however, those skilled in the art of debt collection and those of skill in the art of computer science will appreciate that the steps of the methodology depicted in FIG. 2-1, 2-2 and 2-3 could also be practiced with the aid of an appropriately programmed digital computer.

In the steps depicted in FIG. 2-1, historical data is acquired, read or otherwise obtained for all debtors of a population of debtors in step 202. This data may include all of the data described in FIG. 1, as well as any other data that may assist in debt collection.

In step 204, debtors of a creditor who have been delinquent during any point of their indebtedness to the creditor are identified. A delinquent debtor is considered to be a debtor having an unpaid and/or over due credit account balance. By way of example, a late payment on a revolving credit account can be considered to be delinquent.

For a variety of reasons, not all debtors of a creditor are subjected to collection attempts. Some debtors might simply be dead or otherwise unreachable. A creditor might consider some indebtedness amounts to be too insignificant to warrant collection attempts. Of the population of all debtors of a creditor who are identified in step 204 to have ever been delinquent, the debtors from whom a collection was attempted are identified in step 206.

Of course, the step of identifying debtors from whom collection was attempted presumes the existence of records or other information from which it can determined whether collection was attempted from a debtor. If a creditor does not maintain collection efforts, tracking and improving debt collection becomes problematic. Most creditors maintain some record of collection attempts made against delinquent debtors. Identifying the debtors from whom collection was attempted can sometimes require manually combing paper records. Other creditors will record debt collection attempts (contacts to the debtor) on computer readable media. A key step in the methodology disclosed herein is identifying debtors from whom collection was attempted, from whom collection was realized, and all discernible elements of the treatment strategy employed to obtain the payment.

Of the delinquent debtors identified in step 206 as debtors from whom collection was attempted, those debtors who paid at least part of their indebtedness after collection was attempted are identified in step 208. Being “identified” can mean inclusion in a list of debtors who have paid. Being “identified” can occur by the debtor's identity being marked in a database; the debtor's name or other identification being added to or removed from a database.

Payment made by a delinquent debtor on a delinquent account, after an attempted collection, at least implies that the payment received after a collection attempt was a result of the collection attempt. It can also be inferred that whatever technique, message or strategy that was used against the debtor was successful, at least with respect to the debtor who was contacted and paid.

Step 208 identifies debtors who responded favorably to a collection attempt and yields a list of the delinquent debtors from whom a collection attempt proved to be successful. For purposes of this disclosure, even a partial payment on a delinquent account is considered to be a successful collection attempt.

Creditors with a large number of debtors, a number of which are delinquent, will recognize that of a population of delinquent debtors, at least some delinquent debtors will share certain socio-psycho-demographic characteristics. By way of example, delinquent debtors with a particular education level, of a particular gender, having a particular income level and having a particular number of dependent children, are likely to have similar responses to a particular collection strategy. The step 208 of determining in a population of all delinquent debtors, the delinquent debtors from whom collection was attempted and from whom at least a partial payment was received is identified, will yield a list of delinquent debtors that responded to a collection attempt.

In step 210, all of the collection strategies that were used against all of the delinquent debtors identified in step 208 are identified. As a result, in step 210, a list of the debt collection strategies is created or identified that is a list of strategies that yielded a payment from delinquent debtors (as evidenced by the payments received from the previously-delinquent debtors).

For purposes of this disclosure, a collection strategy is considered to be any technique, process or message used to obtain at least a partial payment. A collection strategy can include, but is not limited to: sternly-worded or conciliatory letters to the debtor; telephone calls by which certain warnings, or even overt threats of litigation are made; personal contacts requesting repayment; offers to forego late payment charges in exchange for a timely payment; offers to forgive part of an outstanding debt in exchange for payment; offers to extend the amortization schedule or repayment time in exchange for payment; timing of the contact (time of day, day of week, time of month, days since account has gone delinquent, etc.); attributes of the collector initiating the communication (if by phone); etc.

Those of skill in the art of debt collection know that different debtors can often respond differently to the same debt collection technique. Accordingly, many creditors use different debt collection techniques on different debtors. Heretofore however, determining which technique to use on a particular debtor has been based on trial and error (Champion/Challenger experimentation), while elements of the treatment strategy have been left to the intuition of the particular collector interacting with the debtor. By selectively using a treatment strategy on a delinquent debtor that is known to have been previously used successfully against other, similar debtors, the likelihood of successful collection from the delinquent debtor is increased on the first attempt to collect a debt.

In FIG. 2-2, at step 212, all of the collection strategies that were successfully used by a creditor against delinquent debtors are identified. A successful collection strategy is considered to be an identifiable strategy which yielded at least a partial payment of the indebtedness. Accomplishing step 212 will require a creditor to have records of the techniques or strategies it used against the delinquent debtors from whom payments were subsequently received. Performing step 212 will sometimes require a manual review of records to determine what sort of collection strategy was used that yielded a resultant payment. In other more automated debt collection entities, computer-readable records can be searched to identify a technique or techniques that yielded payment from a delinquent debtor.

At step 214, for each collection strategy identified in step 212, the delinquent debtors against whom the strategy was successfully used are identified. In other words, each strategy determined to have been used successfully, is correlated to the debtors against whom the strategy was employed. As a result of step 214, there should exist lists of the delinquent debtors who responded positively to a corresponding debt collection strategy.

In step 216, demographic (or other) characteristics of debtors who were treated with a particular debt collection strategy are filtered in order to determine if there is any one or more socio-psycho-demographic characteristic that, when used alone or in conjunction with financial and/or payment history data, at least some of the positively-responding delinquent debtors share with each other. By way of example, for a set of three different debt collection strategies identified as Strategy A, Strategy B and Strategy C, delinquent debtors who responded positively to Strategy A might have similar educational levels, similar income levels and the same number of dependent children. In step 216, available data of delinquent debtors is examined to ascertain if any of the debtors who responded to a particular debt collection strategy share any one or more characteristics. Those common characteristics are catalogued in step 218 as indicia that other debtors having the same characteristics might also respond positively to the same collection strategy that was previously used successfully on the debtors who previously responded successfully to the same strategy. Practitioners in the area of statistical analysis will recognize that the determination of correlations between successful treatments and debtor characteristics may be pursued through the use of a variety of statistical modeling techniques provided through commercially available software packages, or for smaller quantities of data, calculable by hand. Such techniques include but are not limited to linear regression, logistic regression, non-linear regression, ANOVA, neural network models, multiple discriminate analysis, etc.

Some characteristics that can be used to characterize debtors include: age; gender; number of dependents; occupation; income; marital status; formal education; number of dependents; employment status; debt-to-income ratio; other indebtedness; geographic area of residence; leisure pursuits; publicly available voter registration information; etc. Not all of the steps described above need to be performed in the order set forth above. By way of example, an equivalent embodiment would performs the step 212 of determining all successful collection strategies before any of steps 210, 208, 206, 204 or 202. The salient aspect of the invention disclosed herein is that collection strategies that have been used successfully against certain debtors, should yield similar success when used against similar debtors. Instead of predicting how one or more collection strategies might work on debtors, historical data showing what strategies have worked in the past can predict strategies likely to work in the future.

It is to be understood that a wide range of changes and modifications to the embodiments described above will be apparent to those skilled in the art and are contemplated. It is, therefore, intended that the foregoing detailed description be regarded as illustrative rather than limiting, and that it be understood that it is the following claims, including all equivalents, that are intended to define the spirit and scope of the invention.

What is claimed is:

1. A method of debt collection from a plurality of debtors comprising the steps of:
identifying a first set delinquent debtors comprised of debtors from whom a debt collection has been attempted;
from the first set delinquent debtors, identifying a first subset of delinquent debtors from whom debt collection was successful;
identifying a collection strategy that was used successfully against the first subset of delinquent debtors;
identifying at least one characteristic of said first subset of delinquent debtors from which delinquent account collection was successful using said collection strategy;
attempting delinquent account collection from other delinquent debtors having said at least one characteristic, using said collection strategy.

2. The method of claim 1 wherein said delinquent debtors are characterized by at least one of: an unpaid credit account balance.

3. The method of claim 1 wherein successful collection is comprised of:
at least a partial payment of a credit account balance.

4. The method of claim 1 wherein the step of identifying a collection strategy is comprised of the following steps:
compiling all possible collection strategies;
identifying at least one collection strategy that was successfully exploited to collect a delinquent account.

5. The method of claim 1 wherein said step of identifying at least one characteristic includes the step of identifying at least one of a credit account holders:
age;
gender;
number of dependents;
occupation;
income;
marital status;
formal education;
number of dependents;
employment status;
debt-to-income ratio;
other indebtedness;
other psychographic, socioeconomic or demographic attributes
